(19) United States
(12) Patent Application Publication
(10) Pub. No.: US 2026/0228415 A1
(43) Pub. Date: Aug. 6, 2026

(54) TECHNOLOGIES FOR PERFORMING LAYOUT CALCULATIONS ASSOCIATED WITH RENDERING CONTENT

(71) Applicant: CIMPRESS SCHWEIZ GMBH, Winterthur (CH)

(72) Inventors: Christina Kayastha, Somerville, MA (US); Brian Hanechak, Arlington, MA (US); Nathaniel Woods, Waltham, MA (US)

(21) Appl. No.: 19/153,292

(22) PCT Filed: Feb. 1, 2024
(86) PCT No.: PCT/IB2024/050937

§ 371 Date: Aug. 1, 2025

Related U.S. Application Data
(60) Provisional application No. 63/442,961, filed on Feb. 2, 2023.

(51) Int. Cl. G06F 40/106; G06F 40/131

(52) U.S. Cl. CPC G06F 40/106; G06F 40/131

(57) ABSTRACT

Methods and systems are described herein for consistently rendering documents across multiple platforms. The method may include: accessing, by a client device communicating with a server-side computing device, a document comprising components formatted according to a set of design elements; dividing, using a platform-agnostic library, the document into a plurality of subsections; generating, using the platform-agnostic library, lines of the document based on a size for each subsection of the plurality of subsections; generating, using the platform-agnostic library, a data structure by determining a position for each sub-element in each line of the lines of the document, wherein the data structure is consistent across a plurality of different platforms; and providing the data structure to a painting module stored on the client device.

### CROSS-REFERENCE TO RELATED APPLICATIONS

This application claims priority to and the benefit of the filing date of provisional U.S. Patent Application No. 63/442,961 entitled “TECHNOLOGIES FOR CONSISTENTLY RENDERING DIGITAL DESIGNS ACROSS MULTIPLE PLATFORMS,” filed on Feb. 2, 2023. The entire content of the provisional application is hereby expressly incorporated herein by reference.

### TECHNICAL FIELD

The present disclosure generally relates to techniques and improvements related to consistently performing digital design rendering across multiple platforms.

### BACKGROUND

When utilizing digital design techniques, users often use design documents including text and non-text elements to generate a design. Because these designs are usually created to be eye-catching or otherwise visually appealing, it is important to display the design properly and ultimately create a product using the same design as initially generated. As such, it is important to ensure that digital designs are consistently rendered across platforms. While there are some existing techniques for rendering designs, such designs are either resource intensive or risk inconsistent rendering if the user or manufacturer uses a different platform. For example, server side rendering, where each client application would need to make a request to a server to get a bitmap rendering of a design element as an image, require large quantities of data to be transferred back and forth between a client and service device, causing excessive bandwidth usage. Similarly, using browser-based techniques on a client leads to reduced network usage, but causes inconsistent rendering across multiple platforms, as the browsers may use different proprietary code to render the designs. As such, glyph placement may be different between platforms, text wrapping may be misaligned between platforms, shapes may be displayed differently between platforms, etc.

### SUMMARY

In an embodiment, a computer-implemented method of consistently rendering design documents across multiple platforms is provided. The computer-implemented method may include: accessing, by at least one processor of a client device communicating with a server-side computing device, a document comprising components formatted according to a set of design elements; dividing, by the at least one processor and using a platform-agnostic library, the document into a plurality of subsections; generating, by the at least one processor and using the platform-agnostic library, lines of the document based on a size for each subsection of the plurality of subsections; generating, by the at least one processor and using the platform-agnostic library, a data structure by determining a position for each sub-element in each line of the lines of the document, wherein the data structure is consistent across a plurality of different platforms; and providing, by the at least one processor, the data structure to a painting module stored on the client device.

In another embodiment, a computing system configured to consistently render documents across multiple platforms is provided. The computing system may include: at least one processor of a client device communicating with a server-side computing device; and a memory of the client device storing one or more instructions that, when executed by the at least one processor, cause the client device to: access a document comprising components formatted according to a set of design elements; divide, using a platform-agnostic library, the document into a plurality of subsections; generate, using the platform-agnostic library, lines of the document based on a size for each subsection of the plurality of subsections; generate, using the platform-agnostic library, a data structure by determining a position for each sub-element in each line of the lines of the document, wherein the data structure is consistent across a plurality of different platforms; and provide the data structure to a painting module stored on the client device.

In yet another embodiment, a tangible, non-transitory computer-readable medium storing instructions for consistently rendering documents across multiple platforms is provided. The instructions may, when executed by at least one processor, cause a client device to: access a document comprising components formatted according to a set of design elements; divide, using a platform-agnostic library, the document into a plurality of subsections; generate, using the platform-agnostic library, lines of the document based on a size for each subsection of the plurality of subsections; generate, using the platform-agnostic library, a data structure by determining a position for each sub-element in each line of the lines of the document, wherein the data structure is consistent across a plurality of different platforms; and provide the data structure to a painting module stored on the client device.

In a further embodiment, a computer-implemented method of consistently rendering design documents across multiple platforms is provided. The computer-implemented method may include: receiving, by at least one processor of a client device communicating with a server-side computing device, a data structure indicative of a layout for one or more design elements for a document; generating, by the at least one processor and using a platform-agnostic library, layout measurement data based on the data structure, wherein the layout measurement data is consistent across a plurality of different platforms; generating, by the at least one processor and using the platform-agnostic library, one or more painting operations based on the data structure; and painting, by the at least one processor, element layouts at the client device based on the generated layout measurement data and the one or more painting operations.

In another further embodiment, a computing system configured to consistently render documents across multiple platforms is provided. The computing system may include: at least one processor of a client device communicating with a server-side computing device; and a memory of the client device storing one or more instructions that, when executed by the at least one processor, cause the client device to: receive a data structure indicative of a layout for one or more design elements for a document; generate, using a platform-agnostic library, layout measurement data based on the data structure, wherein the layout measurement data is consistent across a plurality of different platforms; generate, using the platform-agnostic library, one or more painting operations based on the data structure; and paint element layouts at the client device based on the generated layout measurement data and the one or more painting operations.

In yet another embodiment, a tangible, non-transitory computer-readable medium storing instructions for consistently rendering documents across multiple platforms is provided. The instructions may, when executed by at least one processor, cause a client device to: receive a data structure indicative of a layout for one or more design elements for a document; generate, using a platform-agnostic library, layout measurement data based on the data structure, wherein the layout measurement data is consistent across a plurality of different platforms; generate, using the platform-agnostic library, one or more painting operations based on the data structure; and paint element layouts at the client device based on the generated layout measurement data and the one or more painting operations.

In a still further embodiment, a computer-implemented method of consistently rendering design documents across multiple platforms is provided. The computer-implemented method may include: accessing, by at least one processor of a client device, layout measurement data based on a data structure indicative of a layout for one or more design elements for a document; rendering, by the at least one processor, one or more editing user interface elements for inline editing based on the one or more design elements; receiving, by the at least one processor, one or more inputs from a user; and causing, by the at least one processor, a painted layout displayed to a user to be re-rendered in real-time by editing the document in real-time based on the one or more inputs from the user.

In another further embodiment, a computing system configured to consistently render documents across multiple platforms is provided. The computing system may include: at least one processor of a client device communicating with a server-side computing device; and a memory of the client device storing one or more instructions that, when executed by the at least one processor, cause the client device to: access layout measurement data based on a data structure indicative of a layout for one or more design elements for a document; render one or more editing user interface elements for inline editing based on the one or more design elements; receive one or more inputs from a user; and cause a painted layout displayed to a user to be re-rendered in real-time by editing the document in real-time based on the one or more inputs from the user.

In yet another embodiment, a tangible, non-transitory computer-readable medium storing instructions for consistently rendering documents across multiple platforms is provided. The instructions may, when executed by at least one processor, cause a client device to: access layout measurement data based on a data structure indicative of a layout for one or more design elements for a document; render one or more editing user interface elements for inline editing based on the one or more design elements; receive one or more inputs from a user; and cause a painted layout displayed to a user to be re-rendered in real-time by editing the document in real-time based on the one or more inputs from the user.

### BRIEF DESCRIPTION

The figures described below depict various aspects of the system and methods disclosed therein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

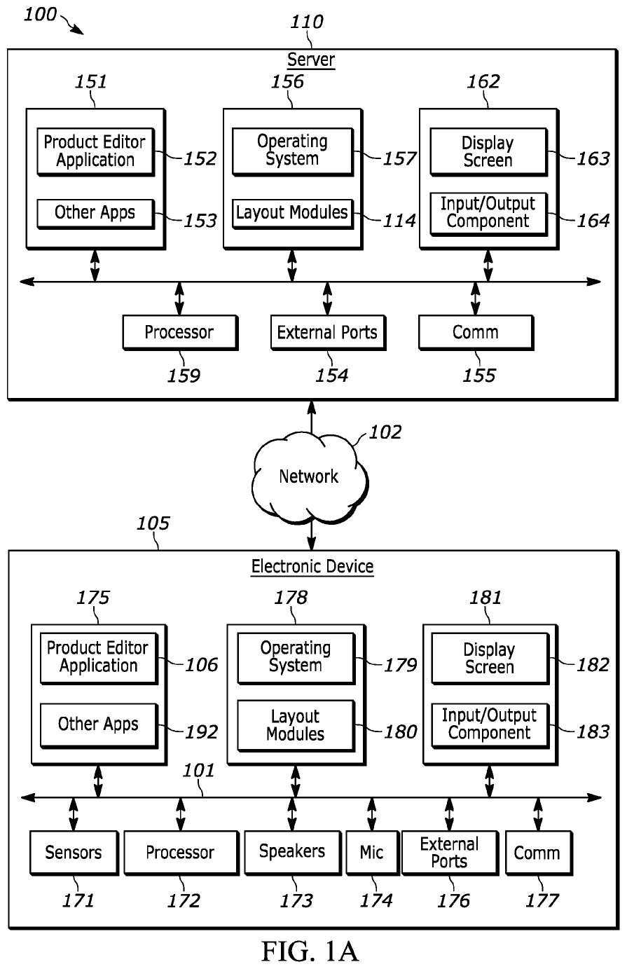

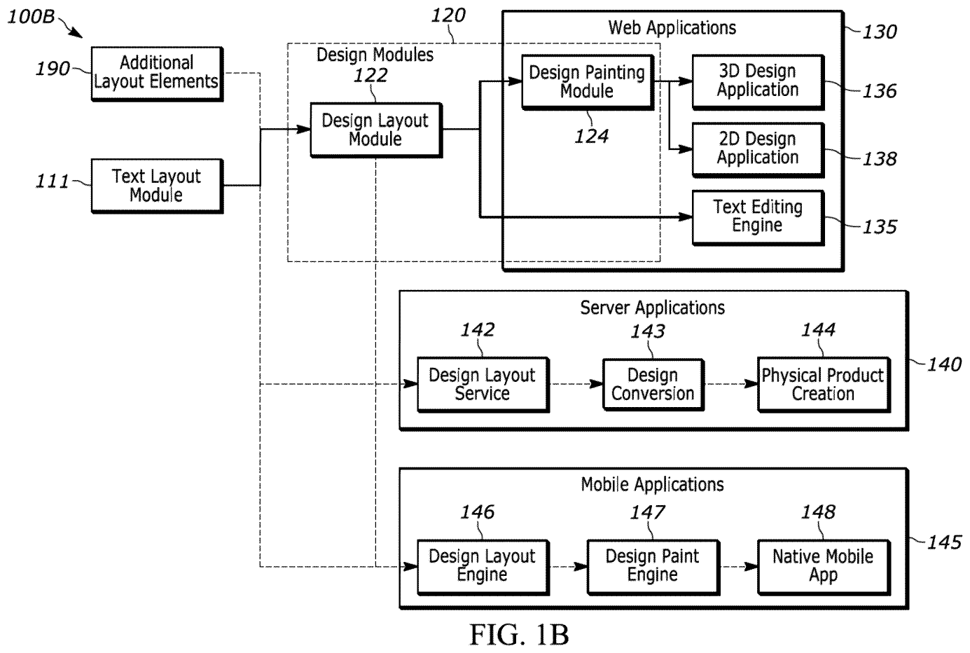

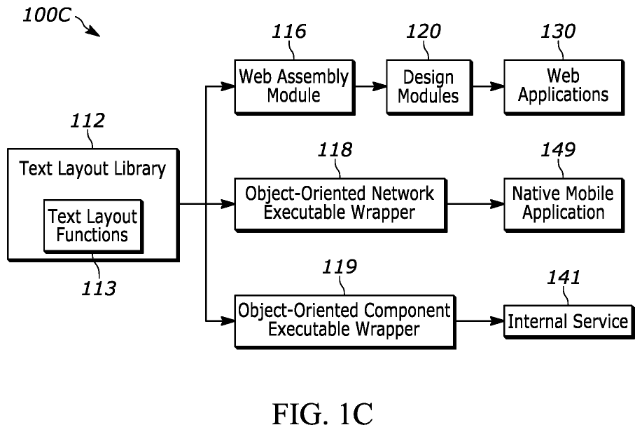

FIG. 1A illustrates a block diagram depicting an exemplary computing system including a server and a client device for performing calculations for design layouts and rendering the designs as calculated.

FIG. 1B illustrates a block diagram depicting an exemplary system including various modules for performing calculations for design layouts and rendering the designs as calculated, implemented in the environment of FIG. 1A.

FIG. 1C illustrates a block diagram depicting an exemplary system including various modules for performing calculations for design layouts and rendering the designs as calculated, similar to that of FIG. 1B, but including a layout library.

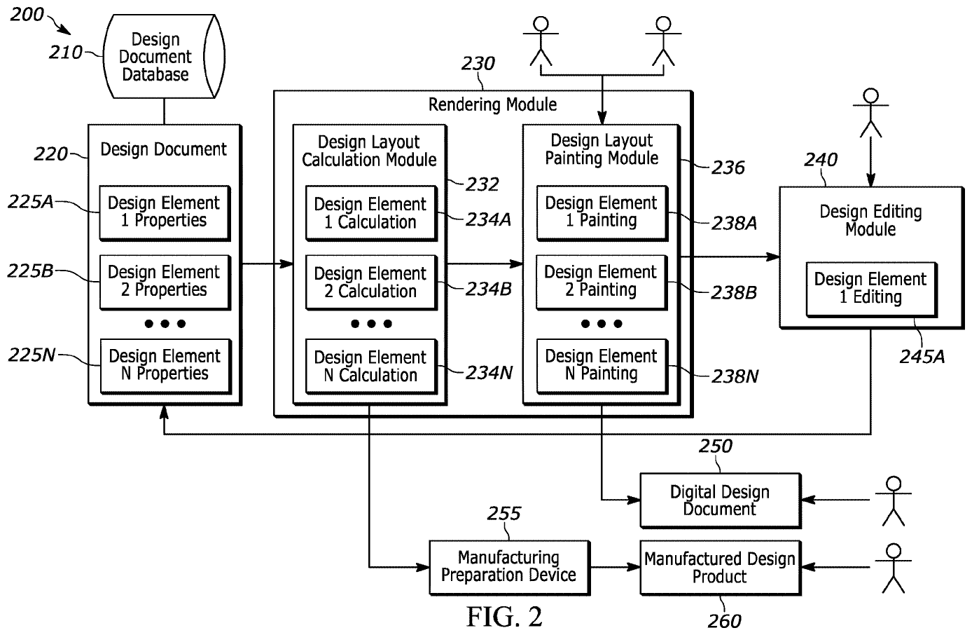

FIG. 2 illustrates a block diagram depicting an exemplary system including various modules for calculating and painting design layouts for manufacturing and/or digital distribution to a user, implemented in the environment of FIG. 1A.

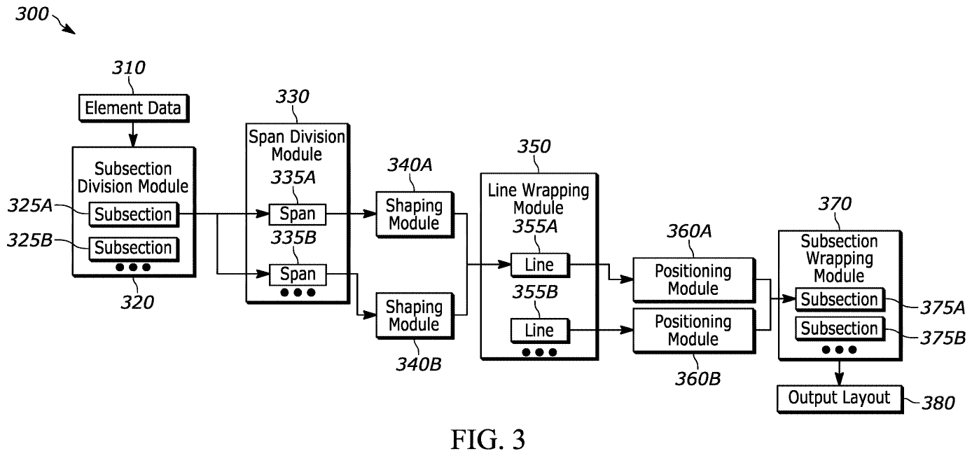

FIG. 3 illustrates a block diagram depicting an exemplary system for calculating layout measurements for particular elements of a larger design document, implemented in the environment of FIG. 1A.

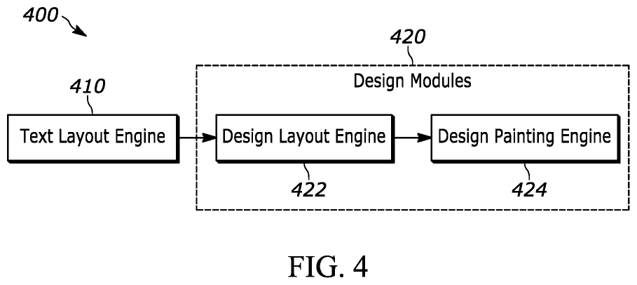

FIG. 4 illustrates a block diagram depicting an exemplary system for calculating layout measurements for an overall design document and painting the design document using calculated layout measurements for particular elements, implemented in the environment of FIG. 1A.

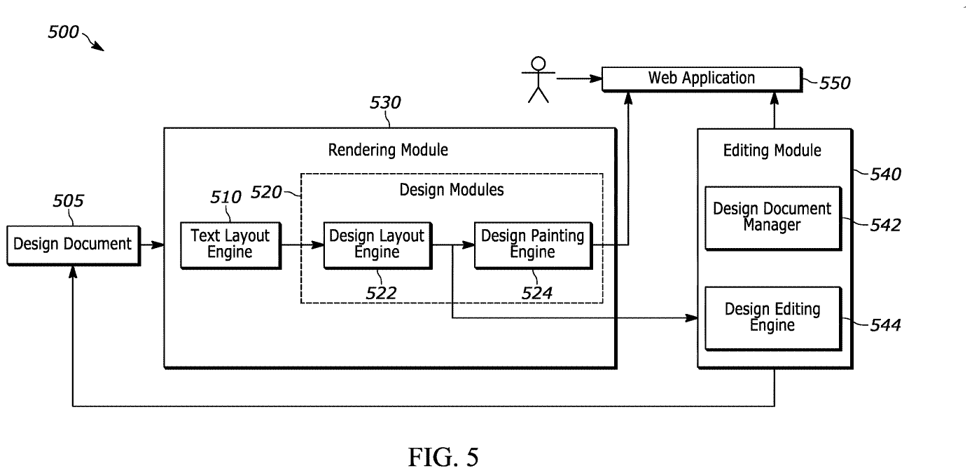

FIG. 5 illustrates a block diagram depicting an exemplary system for rendering and editing display of a design document, implemented in the environment of FIG. 1A.

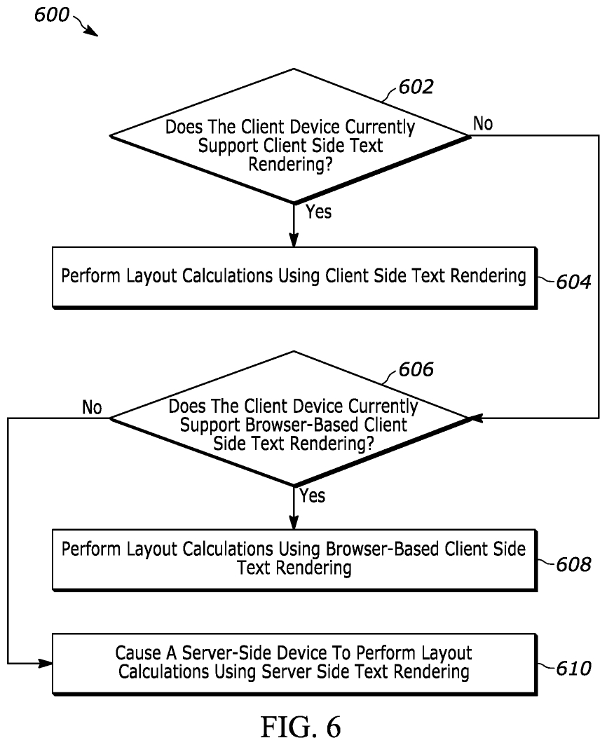

FIG. 6 illustrates a flowchart depicting a method for determining whether to use client side text rendering or other techniques based on whether a device currently supports the rendering technique(s), implemented in the environment of FIG. 1A.

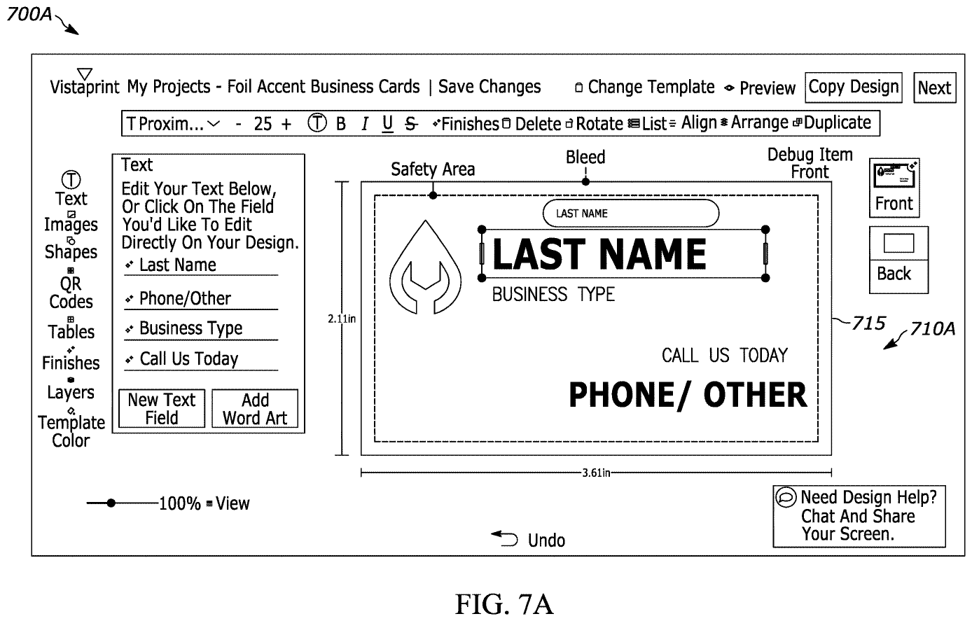

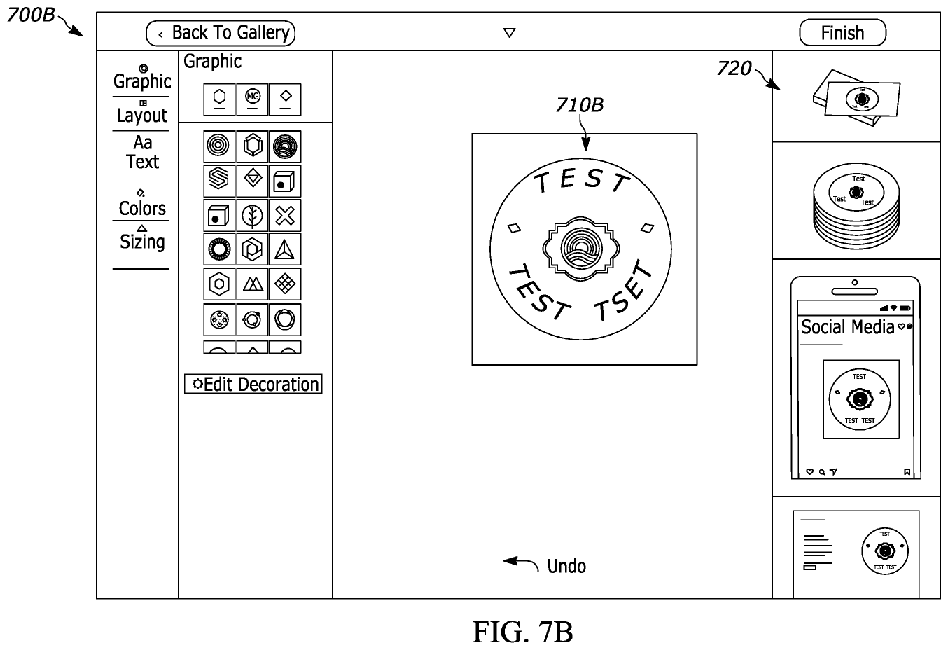

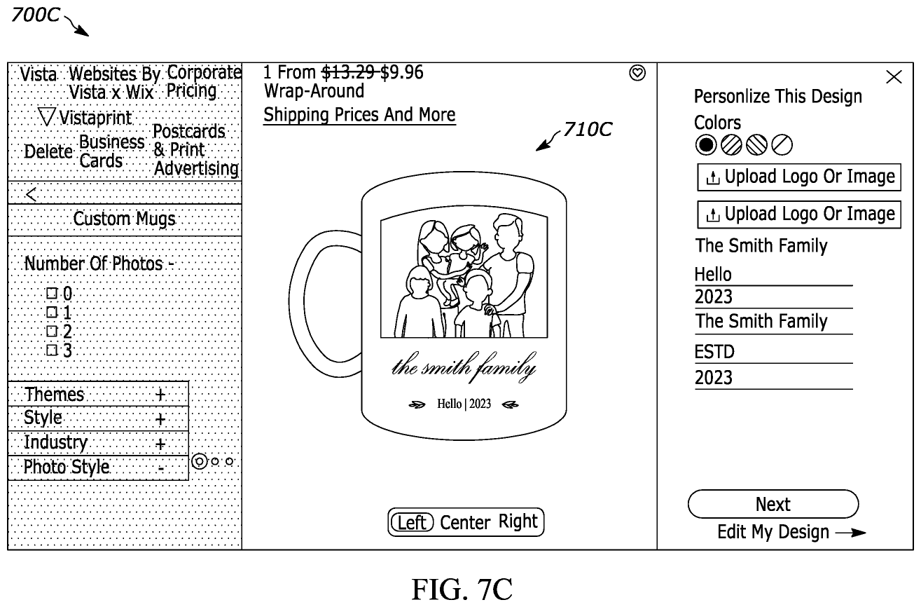

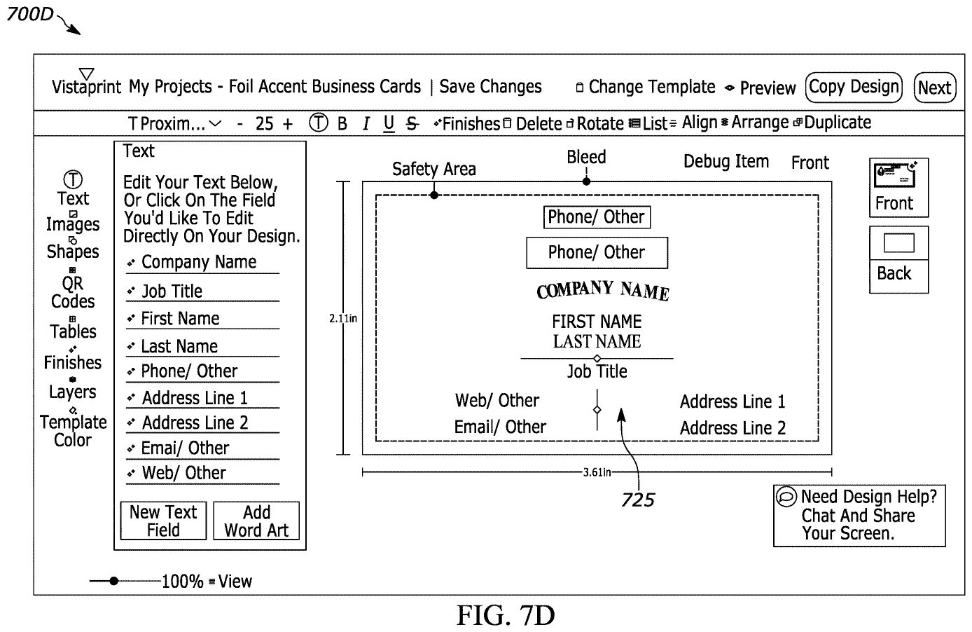

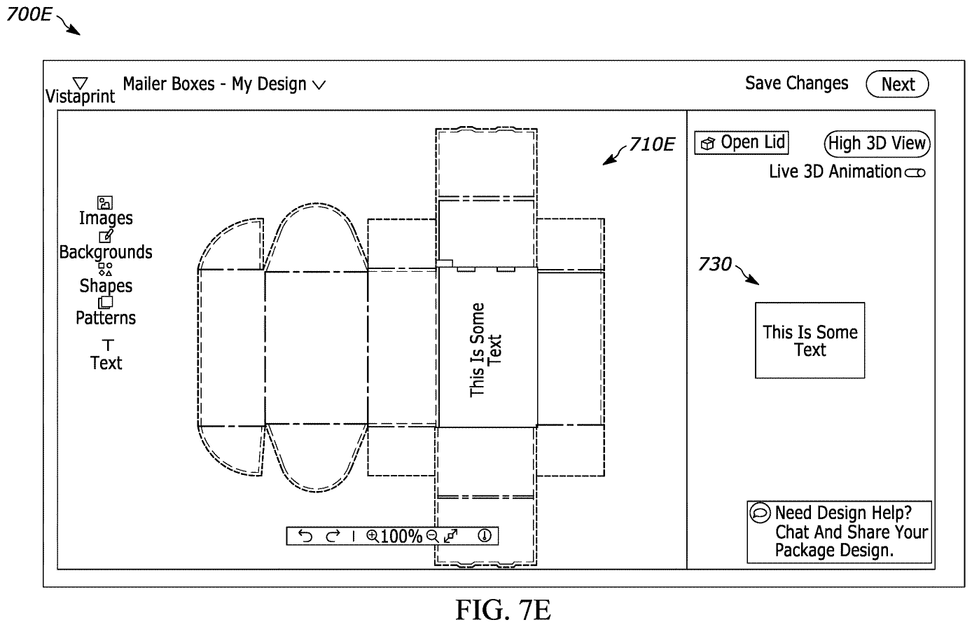

FIGS. 7A-7E illustrate exemplary user interfaces, each depicting an exemplary design rendered and/or edited according to the techniques described herein.

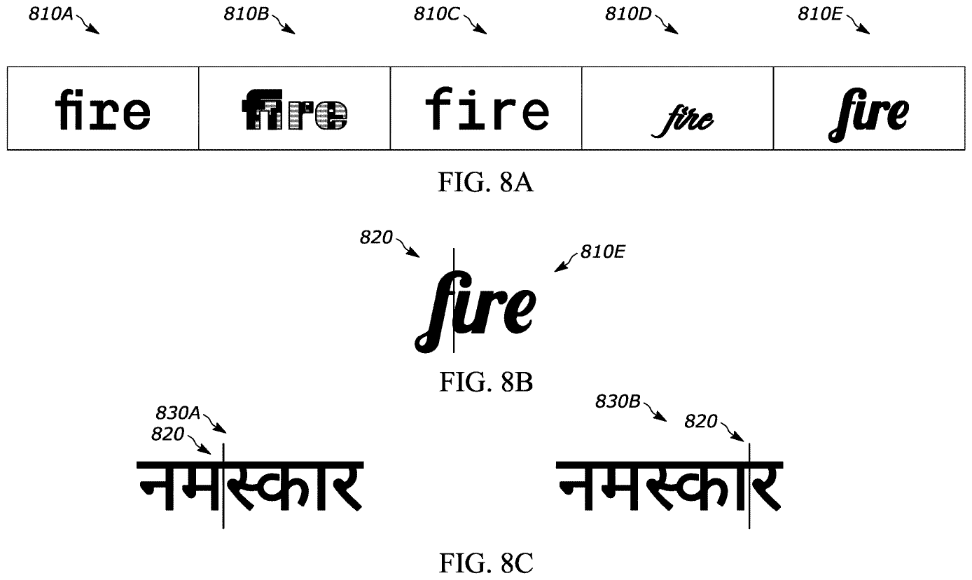

FIGS. 8A-8C illustrate exemplary spans representative of a word, each containing glyphs as determined based on font and/or language characteristics according to the techniques described herein.

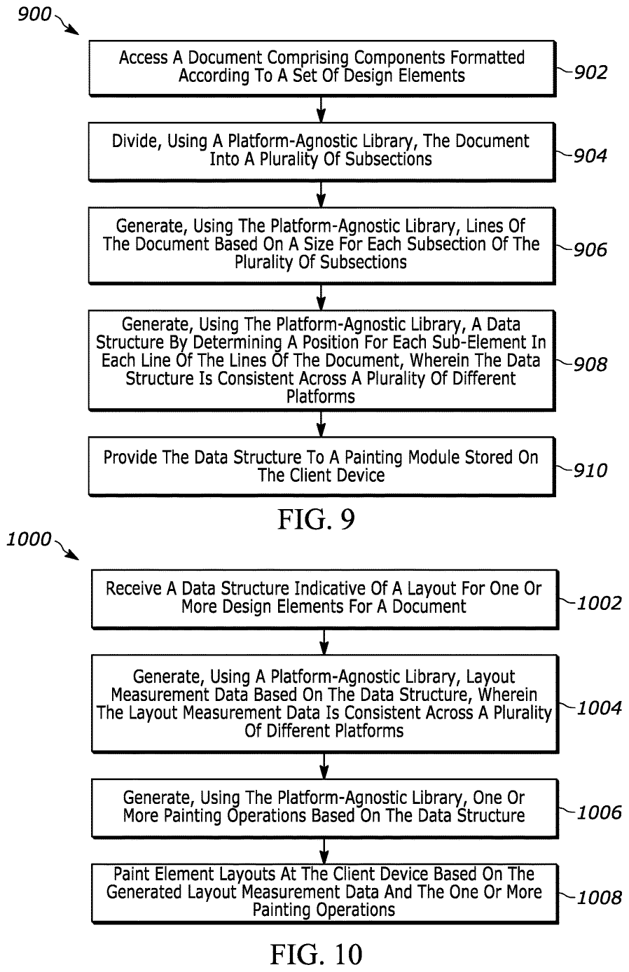

FIG. 9 illustrates a flowchart depicting a method for generating a data structure representative of positions for elements on a design, implemented in the environment of FIG. 1A.

FIG. 10 illustrates a flowchart depicting a method for painting element layouts at a client device based on generated layout measurement data, implemented in the environment of FIG. 1A.

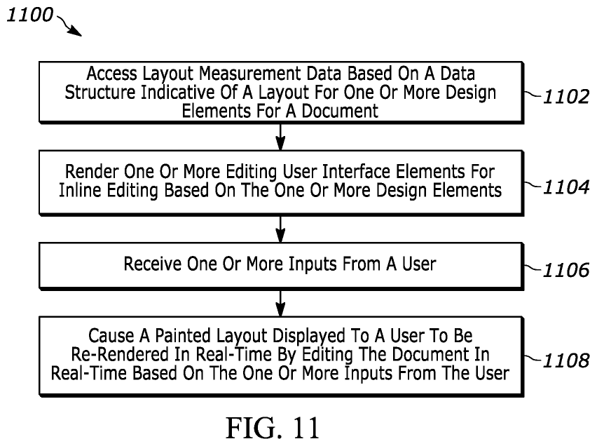

FIG. 11 illustrates a flowchart depicting a method for rendering and editing elements of a design document, implemented in the environment of FIG. 1A.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

Techniques, systems, apparatuses, components, devices, and methods are disclosed for, inter alia, calculating design layouts, painting the designs, and editing the designs in real-time.

The instant techniques provide various benefits and improvements over current techniques. For example, by implementing the instant techniques on the client side rather than on the server side, the instant techniques greatly reduce network traffic and latency. Moreover, by using a platform-agnostic library (e.g., agnostic to platforms including web browser, native application, server, etc.) to perform the design layout calculations and/or painting, a user is able to use any network for design capability rather than a particular matching network (e.g., such as the same browser) without risking an incorrect design due to inconsistencies in library code between native network libraries. Further, by rendering in real-time using the client device, the instant techniques allow for an improved user experience in the form of real-time rendering without excessive lag in response time and/or a separate pop-up box with a delay. Rather, the instant techniques provide an improved user experience by allowing for inline text editing capabilities in real-time.

FIG. 1A illustrates a hardware diagram of a system 100A of components configured to facilitate the systems and methods, including an electronic device 105, a server 110, and a network 102. It should be appreciated that the system 100 is merely an example and that alternative or additional components are envisioned.

As illustrated in FIG. 1A, the system 100 may include one or more electronic devices 105, which may be operable by a user. The user may be any individual or person who may be interested in purchasing items, products, and/or services that may be offered for sale by an entity. Additionally or alternatively, the user may be any individual or person who provides assistance to another user on behalf of the entity. In an embodiment, the entity may be a corporation, company, partnership, retailer, wholesaler operating on behalf of another entity (e.g., a white label wholesaler), or the like, where the entity may offer an e-commerce platform in the form of a design studio (e.g., a website, a web application, a dedicated application) accessible or executable by the electronic device 105) and optionally a set of brick-and-mortal retail stores. The electronic device 105 may be any type of electronic device, such as a mobile device (e.g., a smartphone), desktop computer, notebook computer, tablet, phablet, GPS (Global Positioning System) or GPS-enabled device, smart watch, smart glasses, smart bracelet, wearable electronic, PDA (personal digital assistant), pager, computing device configured for wireless communication, and/or the like.

The electronic device 105 may include a processor 172 as well as a memory 178. The memory 178 may store an operating system 179 capable of facilitating the functionalities as discussed herein as well as a set of applications 175 (i.e., machine readable instructions). For example, one of the set of applications 175 may be a product editor application 106 configured to facilitate certain product designing functionalities as discussed herein. It should be appreciated that one or more other applications 192, such as a web browser application, are envisioned.

The processor 172 may interface with the memory 178 to execute the operating system 179 and the set of applications 175. Memory 178 may store layout modules 180 that may receive data collected by and/or provide data to the set of applications 175. It will be understood that, although both the electronic device 105 and server 110 are displayed as including the layout modules 114 and 180, respectively, the layout modules 114 at the server 110 may, in some implementations, be used as a backup rather than as a primary set.

The memory 178 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The electronic device 105 may further include a communication module 177 configured to communicate data via one or more networks 102. According to some embodiments, the communication module 177 may include one or more transceivers (e.g., WWAN, WLAN, and/or WPAN transceivers) functioning in accordance with IEEE standards, 3GPP standards, or other standards, and configured to receive and transmit data via one or more external ports 176.

The electronic device 105 may include a set of sensors 171 such as, for example, a location module (e.g., a GPS chip), an image sensor, a clock, a gyroscope (i.e., an angular rate sensor), a compass, a tilt sensor, and/or other sensors. The electronic device 105 may further include a user interface 181 configured to present information to a user and/or receive inputs from the user. As shown in FIG. 7, the user interface 781 may include a display screen 182 and I/O components 183 (e.g., ports, capacitive or resistive touch sensitive input panels, keys, buttons, lights, LEDs). According to some embodiments, the user may access the electronic device 105 via the user interface 181 to review information such product renderings, make design selections and modifications, and/or perform other functions. Additionally, the electronic device 105 may include a speaker 173 configured to output audio data and a microphone 174 configured to detect audio, for use during a video session integrated with the collaborative communication session, for example.

In some embodiments, the electronic device 105 may perform the functionalities as discussed herein as part of a “cloud” network or may otherwise communicate with other hardware or software components within the cloud to send, retrieve, or otherwise analyze data.

The electronic device 105 may communicate with a central server 110 via one or more networks 102. The server 110 may be associated with the entity that owns and/or manages the e-commerce platform(s) and/or the set of brick-and-mortal retail stores. In particular, the server 110 may include or support a web server configured to host a website that offers various products and/or services for purchase by users. Further, the server 110 may support a software application executable by the electronic device(s) 105 (i.e., the electronic device(s) 105 may interface with the server 110 in executing the software application). In embodiments, the network(s) 102 may support any type of data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others).

Although depicted as a single server 110 in FIG. 1, it should be appreciated that the server 110 may be in the form of a distributed cluster of computers, servers, machines, or the like. In this implementation, the entity may utilize the distributed server(s) 110 as part of an on-demand cloud computing platform. Accordingly, when the electronic device(s) 105 interface with the server 110, the electronic device(s) 105 may actually interface with one or more of a number of distributed computers, servers, machines, or the like, to facilitate the described functionalities.

The server 110 may be configured to interface with or support a memory or storage capable of storing various data, such as in one or more databases (not shown) or other forms of storage. According to embodiments, the memory and/or database may store data or information associated with products or services that are offered for sale by the entity that owns and/or manages the e-commerce platform and/or the set of brick-and-mortal retail stores. Particularly, the memory and/or database may store layout modules 114 and/or data associated with the layout modules 114, corresponding to modules for determining layout for text and non-text elements of a design document, calculating overall layout for a design document, painting and/or rendering the elements of the design document based on the calculated layouts, editing the rendered version of the design document, etc. The memory and/or database may also store protected and/or public domain digital images and/or design elements, templates of designs, as well as information associated with the designs, including properties of the elements/components of the designs. The images and design elements may be sorted, classified, categorized, and/or the like.

As illustrated in FIG. 1A, the server 110 may include a processor 159 as well as a memory 156. The memory 156 may store an operating system 157 capable of facilitating the functionalities as discussed herein as well as a set of applications 151 (i.e., machine readable instructions). For example, one of the set of applications 151 may be a product editor application 152 configured to facilitate various of the product design functionalities discussed herein. It should be appreciated that one or more other applications 153 are envisioned.

The processor 159 may interface with the memory 156 to execute the operating system 157 and the set of applications 151. The memory 156 may store layout modules 114 that may receive data collected by and/or provide data to the set of applications 151. The memory 156 may include one or more forms of volatile and/or non-volatile, fixed, and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The server 110 may further include a communication module 155 configured to communicate data via the one or more networks 102. According to some embodiments, the communication module 155 may include one or more transceivers (e.g., WWAN, WLAN, and/or WPAN transceivers) functioning in accordance with IEEE standards, 3GPP standards, or other standards, and configured to receive and transmit data via one or more external ports 154. For example, the communication module 155 may receive, from the electronic device 105, requests for assistance.

The server 110 may further include a user interface 162 configured to present information to a user and/or receive inputs from the user. As shown in FIG. 1A, the user interface 162 may include a display screen 163 and I/O components 164 (e.g., ports, capacitive or resistive touch sensitive input panels, keys, buttons, lights, LEDs). According to some embodiments, the user may access the server 110 via the user interface 162 to review information, provide assistance to a customer, make changes, and/or perform other functions.

In some embodiments, the server 110 may perform the functionalities as discussed herein as part of a “cloud” network or may otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code may be adapted to be executed by the processors 172, 159 (e.g., working in connection with the respective operating systems 179, 157) to facilitate the functions as described herein. In this regard, the program code may be implemented in any desired language, and may be implemented as machine code, assembly code, byte code, interpretable source code or the like (e.g., via Golang, Python, Scala, C, C++, Java, Actionscript, Objective-C, Javascript, CSS, XML). In some embodiments, the computer program product may be part of a cloud network of resources.

Although one (1) electronic device and one (1) server 110 are depicted in FIG. 1A, it should be appreciated that alternate amounts are envisioned. For example, there may be multiple servers, each one associated with a different entity.

According to embodiments, the user may use the electronic device 105 to facilitate a shared session to edit a design for a printed product. The printed product may be a print, promotional, embroidery, or engraving, or other suitable product, such as those offered by Vistaprint®.

FIG. 1B illustrates a block diagram of an exemplary architecture for an example system 100B, configured to perform isomorphic rendering of one or more design elements as described herein. In particular, the system 100B may perform layout calculations for text or other design elements, calculate an overall layout of a design document, paint a design document, and handle user interactions during editing. It will be understood that additional, less, and/or alternate functionality is also anticipated.

Depending on the implementation, the system 100B may include a text layout module 110, a design module 120, web applications 130, server applications 140, mobile applications 145, and/or additional layout elements 190. In some implementations, the system 100B may be implemented on components of FIG. 1A (e.g., mobile device 105, server 110, and/or network 102). It will be understood that additional, fewer, and/or alternate components are anticipated. For example, functionality described as being performed by two modules may be performed by a single module except where otherwise noted. Similarly, functionality performed by a single module may be divided between multiple modules and/or performed by multiple modules functioning together.

In some implementations, the text layout module 110 performs one or more text layout calculations for determining text for a canvas (e.g., on an example product). Depending on the implementation, the text layout module 110 operates according to a platform-agnostic library including one or more executables to be run on the web, such as web assembly (e.g., WASM, Rust, etc.). In some implementations, a library may be “platform-agnostic” where the library or executables perform operations and functionalities consistently across multiple operating systems, browsers, devices, runtimes, etc. For example, conventional techniques may utilize native libraries inherent to a browser. As such, changing browsers (e.g., between the user design end and the manufacturing end) may cause undesired modifications in the generated end design.

In some implementations, the server (e.g., server 110 of FIG. 1A) transmits the text layout library to the client device (e.g., electronic device 105), where the client device stores the text layout library for later use. Depending on the implementation, the client device may be a browser, native phone, server, etc.

In some implementations, the server transmits the library upon initial startup of an application. In further implementations, the server transmits the library upon receiving an initial request from the client device. In still further implementations, the server transmits the library and/or updates upon start-up, installation, or some other user interaction.

The text layout module then provides the output to one or more design modules 120 (e.g., fusion modules), such as to a design layout module 122. Depending on the implementation, the design layout module 122 may additionally or alternatively receive additional layout elements 190. For example, the additional layout elements 190 may include directly transmission of non-text elements, calculated layouts for non-text elements, calculated layouts for combinations of non-text and text layouts, etc.

The design layout module 122 receives the text layout calculations as an input from the text layout module 110 and/or additional layout elements 190, and calculates an overall layout for a design document (e.g., as fed into or otherwise accessed by the text layout engine 110 and/or additional layout elements 190). The design layout module 122 then transmits the calculated layout for the design document to another one of the design modules 120 (e.g., a design painting module 124) and one or more web applications 130 (e.g., the text editing engine 135).

The design painting module 124 receives the calculated layout for the design document from the design layout module 122. The design painting module 124 may then paint the design document. In some implementations, the design painting module 124 paints the document by outputting models (e.g., renderable document object models (DOMs)). In some implementations, the design painting module 124 outputs the models to a 3D Design application 136, a 2D design application 138, and/or some other design application (not shown), configured to display and interface with a user.

In some implementations, a text editing engine 135 also receives the calculated design document layout as an input from the design layout module 122. The text editing engine 135 handles interactions with the user during text editing, such as user interface (UI) element generation, modification, display, etc. In further implementations, the text editing engine 135 additionally is configured to edit the document by providing edits directly to the document, causing the text layout module 110, other element 190, and/or design layout module 122 to propagate the changes, allowing for an iterative editing process.

In some implementations, the text layout module, additional layout elements 190, and/or design layout module 122 transmit calculations for layouts to one or more server applications 140, mobile applications 145, etc. in addition or alternatively to the web applications 130. In some such implementations, the server applications 140 may receive the calculations for layouts at a design layout service 142 before converting the design documents into an appropriate format (e.g., .pdf, .jpeg, .png, etc.) at the design conversion service 143. The server applications 140 may then transmit the converted documents to a physical product creation service 144 to cause the generation of a physical manufactured product. Similarly, in further implementations, the mobile applications 145 may receive the calculations for layouts at a design layout engine 146 before using a design paint engine 147 to paint the layout, similar to the design painting module 124. A native mobile application 148 may then be used by a user to create designs.

Referring next to FIG. 1C, the figure illustrates an exemplary system 100C detailing system modules for implementing a method for wrapping and rendering design elements. It will be understood that additional, less, and/or alternate functionality is also anticipated.

The system 100C may include a text layout library 112. The text layout library 112 is a platform-agnostic library, as described with regard to FIG. 1B above. Depending on the implementation, the text layout library 112 may be written in a language associated with and/or configured to be executable via web assembly (e.g., Rust, C, etc.). The text layout library may include various text layout functions 113 and/or general layout calculation functionality (e.g., FriBidi. cc, HarfBuzz. cc, Unicode Linebreaks). It will be understood that the text layout library 112 may be used for non-text design elements in addition to or in place of text elements. Similarly, the text layout functions 113 may be or include non-text functions, depending on the implementation.

In some implementations, the text layout library 112 and/or elements of code generated according to the text layout library 112 are compiled at a web assembly module 116 (e.g., WASM). In some implementations, the text layout library may be compiled to be web executable. The design modules 120 then call the web assembly module 116 to retrieve the compiled web assembly library with utility functions (e.g., Javascript utility functions). The web applications 130 then use the design modules 120 and/or outputs of the design modules 120 to render the design document.

In some implementations, the text layout library 112 is additionally compiled by a object-oriented network executable wrapper 118 (e.g., for object-oriented network executables, such as Java or Swift executables), an object-oriented component executable wrapper 119 (e.g., for C #access), and/or other such wrappers (not shown). In some implementations, a native mobile application 149 uses the object-oriented network executable wrapper 118 to access the text layout functions 113. Similarly, an internal service 141 may access the text layout functions 113 via the object-oriented component executable wrapper 119.

Referring next to FIG. 2, the figure illustrates an exemplary system 200 detailing system modules for implementing a method for retrieving, rendering, and editing a design document. In some implementations, the exemplary system 200 includes or is communicatively coupled to elements of the exemplary systems 100A, 100B, and/or 100C of FIGS. 1A-1C. Depending on the implementation, the system 200 includes a design document database 210, a design document 220, a rendering module 230, a design editing module 240, a digital design document 250, a manufacturing preparation device 255, and/or a manufactured design product 260. It will be understood that additional, fewer, and/or alternate elements are also anticipated.

The design document database 210 stores one or more design documents 220. Depending on the implementation, the design document database 210 may be stored on a server-side computing device (e.g., server 110), on a client device (e.g., electronic device 105), on a computing device communicatively coupled to a client device (not shown), etc. Depending on the implementation, the design documents may be and/or may be stored as object data (e.g. JSON).

Each design document 220 stored in the design document database 210 may include one or more design elements and properties. For example, the design document 220 may include N design elements, each including various properties (e.g., design element 1 properties 225A, design element 2 properties 225B, . . . design element N properties 225N) to be used by a rendering module 230 in generating and/or rendering components of the design document. Depending on the implementation, the design elements may include images, text, shapes, objects, and/or other such elements. In further such implementations, the design element properties may include: (i) position and/or rotation properties; (ii) transform properties (e.g., rotation, translate, scale, skew, mirror, etc.); (iii) crop/clipping properties; (iv) text orientation properties (e.g., left to right, right to left, top to bottom, bottom to top, diagonal, etc.); (v) alignment properties (left, right, center, justify); (vi) curved path properties; (vii) font size properties; (viii) font style properties (e.g., bold, italic, underline, strikethrough, etc.); (ix) color properties; (x) stroke properties (e.g., thickness, LineCap, LineJoin, etc.); (xi) corner radius properties; and/or (xii) any other such property for design elements.

The rendering module 230 accesses the design document 220 and uses a design layout calculation module 232 to calculate a layout for each design element of the design document 220. For example, the design layout calculation module 232 generates a design element 1 calculation 234A based on the design element 1 properties 225A, the design element 2 calculation 234B based on the design element 2 properties 225B, . . . , and the design element N calculation 234N based on the design element N properties 225N.

The design layout calculation module 232 then transmits the calculations to the design layout painting module 236. The design layout painting module 236 uses each respective calculation to generate paintings for each element. For example, the design layout painting module 236 generates (e.g., renders) a design element 1 painting 238A using the design element 1 calculation 234A, the design element 2 painting 238B using the design element 2 calculation 234B, . . . , and the design element N painting 238N using the design element N calculation 234N. The design layout painting module 236 may display the rendered elements to one or more users such that the view is consistent between different platforms, as described herein.

The design layout painting module 236 then communicates with (e.g., transmits the paintings and/or calculations to) a design editing module 240. The design editing module 240 receives one or more user inputs (e.g., keystrokes, voice commands, button presses, clicks, touch screen interactions, etc.) from a user for a particular design element (e.g., design element 1 editing 245A). The design editing module 240 updates the design document 220, causing the system 200 to iteratively update the calculations and paintings (e.g., design element 1 calculation 234A and design element 1 painting 238A) in real-time as the user edits the design element.

In some implementations, the design layout calculation module 232 updates and/or transmits the calculations to a manufacturing preparation device 255, which generates a manufactured design product 260 (e.g., a mug, a picture, a business card, etc.) for a user. Similarly, the design layout painting module 236 may update and/or generate a digital design document 250 (e.g., presentation, file, social media post, etc.) for a user. Depending on the implementation, the design layout calculation module 232 and design layout painting module 236 can perform such updates in real-time, upon confirmation of a final design from a user, at predetermined time intervals, etc.

Referring next to FIG. 3, the figure illustrates an exemplary system 300 detailing system modules for implementing a method for calculating a layout for elements of a design document, such as text. In some implementations, the exemplary system 300 includes or is an element of an exemplary system, such as system 100A, 100B, 100C, and/or 200 of FIGS. 1A-2. For example, the exemplary system 300 may be or include the text layout module 110 and/or design layout calculation module 232. It will be understood that additional, fewer, and/or alternate elements are also anticipated.

In the system 300, a subsection division module 320 retrieves, receives, and/or otherwise accesses element data 310. In some implementations, the element data 310 may include one or more properties of one or more elements for a design document (e.g., design document 220). Depending on the implementation, the design elements may include images, text, shapes, objects, and/or other such elements. In further such implementations, the design element properties may include: (i) position and/or rotation properties; (ii) transform properties (e.g., rotation, translate, scale, skew, mirror, etc.); (iii) crop/clipping properties; (iv) text orientation properties (e.g., left to right, right to left, top to bottom, bottom to top, diagonal, etc.); (v) alignment properties (left, right, center, justify); (vi) curved path properties; (vii) font size properties; (viii) font style properties (e.g., bold, italic, underline, strikethrough, etc.); (ix) color properties; (x) stroke properties (e.g., thickness, LineCap, LineJoin, etc.); (xi) corner radius properties; and/or (xii) any other such property for design elements.

The subsection division module 320 may then divide the element data 310 into one or more subsections (e.g., subsection 325A, subsection 325B, etc.). Depending on the implementation, the subsection may be based on pages, element types, paragraphs, etc. The subsection division module 320 then transmits the subsections 325A, 325B, etc. to span division module 330, where the span division module 330 divides each subsection into further spans (e.g., dividing subsection 325A into span 335A, span 335B, etc.). Depending on the implementation, the spans may be based on words (e.g., one span is one word), graphemes (e.g., a smallest unit of a word, such as a character, stroke, segment, etc.), sentences, shape components, etc.). In some implementation, the subsection division module 320 is or includes a plurality of modules, each dedicated to determining a particular set of spans for a given subsection.

After the element data is further divided into spans, the shaping modules (e.g., shaping module 340A, shaping module 340B, etc. (collectively shaping modules 340)) determine a size, position, direction, etc. of each span for the design document. Depending on the implementation, the shaping modules 340 utilize a direction of the language, contents of each span, etc. to generate each glyph in a span and/or determine characteristics of the span. Depending on the implementation, the shaping modules 340 may include a module for each span, multiple modules to handle a larger quantity of spans, a single module to handle all of the spans, etc.

The line wrapping module 350 then takes the outputs of the shaping modules 340 to determine a width for the subsection including each span (e.g., based on the size, direction, position, etc. of each span in the subsection). The line wrapping module 350 then determines lines for the document and composes the spans into lines (e.g., line 355A, line 355B, etc.). The positioning module 360A, positioning module 360B, etc. (collectively, positioning modules 360) then position the lines vertically, horizontally, diagonally, etc. within the respective subsection area based on the alignment and composed lines.

The subsection wrapping module 370 then composes the lines back together into the original subsections (e.g., paragraphs, pages, shapes, etc.) with layout data. For example, the subsection wrapping module 370 may generate the subsection 375A including the data from the spans 335A, 335B, etc. ; the lines 355A, 355B, etc. ; and other such data in the subsection 375A. The subsection wrapping module 370 may perform the same generation for subsection 375B. The subsection wrapping module 370 then outputs the output layout 380 containing the layout position data for each component of the document (e.g., the position data for the text, including lines, spans, paragraphs, etc.). In some implementations, the output layout 380 additionally includes one or more non-text element, such as text effects, text outline, video, animation, shapes, static images, etc.

Referring next to FIG. 4, the figure illustrates an exemplary system 400 detailing system modules for implementing a method for calculating a layout for an overall design document layout. In some implementations, the exemplary system 400 includes or is an element of an exemplary system, such as system 100A, 100B, 100C, and/or 200 of FIGS. 1A-2. For example, the exemplary system 400 may be or include the design modules 120 and/or the rendering modules 230. It will be understood that additional, fewer, and/or alternate elements are also anticipated.

In the system 400, a text layout engine 410 (e.g., similar to and/or including system 300, design layout calculation module 232, text layout module 110, etc.) performs layout calculations for one or more elements of a design document. For example, depending on the implementation, the text layout engine 410 may perform layout calculations for text and/or other elements as described above with regard to FIG. 3.

The design modules 420 then receive the calculations from the text layout engine 410. In some such implementations, the design layout engine 422 receives the calculations from the text layout engine 410 and calculates, using the element layout calculations from the text layout engine 410, an overall layout for the design document. In particular, the design layout engine 422 processes the design document and generates painting operations and layout measurement data as described herein. The design paint engine 424 may then receive the overall layout measurement data and/or painting operations from the design layout engine and paint the layouts (e.g., using shaders such as htmlcanvas, webGL, etc.). In some implementations, the design paint engine 424 renders a single 3D image comprising the entire design document. Editing in real-time under conventional techniques would require large quantities of data to be transmitted to ensure proper rendering of each element of the 3D image. By maintaining the operations on the client side, however, the data does not need to be transmitted across the network, but can instead be edited in real-time via the client device.

Depending on the implementation, the design paint engine 424 renders the image (2D or 3D) to be applied to a physical and/or digital design product. As such, the design paint engine 424 may apply the substrate of the item for the model to the design as displayed on the display screen to a user. As such, the design paint engine 424 may detect a gamut problem (e.g., with the color of the design) and perform a gamut correction operation to properly paint the design (e.g., in another color scheme besides RGB). In further implementations, the design paint engine 424 may generate a video and/or animated design by rendering moving or animated elements.

Depending on the implementation, the design modules 420 receive the library for performing calculations from a server side device and/or the text layout engine 410. In some implementations, the design modules 420 function as a wrapper around the layouting and painting engines described herein. In particular, the design modules 420 may use the library and the received element layout calculations to calculate an overall design layout, using similar techniques as described above with regard to FIG. 3. For example, the design modules 420 may determine a location on a screen and/or display to paint the layout elements for the overall layout. Depending on the implementation, the design modules 420 may calculate and paint a position for both text and non-text elements. Moreover, the design modules 420 may receive layout calculations for individual subsections of the overall design document and may ultimately calculate an overall layout for the combined design document layout. For example, the design modules 420 may receive three subsections depicting three placements for distinct areas of text. The design modules 420 may then determine that there is no overlap between the areas of text and/or adjust the areas of text accordingly, generate painting operations, and paint the design on a user-viewed display. In some implementations, if an error occurs and/or the client device is unable to perform the client side text rendering, the design modules 420 may transmit and/or cause transmission of an indication to perform a fallback operation, as described with regard to FIG. 6 below.

Referring next to FIG. 5, the figure illustrates an exemplary system 500 detailing system modules for implementing a method for calculating a layout for an overall design document layout. In some implementations, the exemplary system 500 includes or is an element of an exemplary system, such as system 100A, 100B, 100C, and/or 200 of FIGS. 1A-2. For example, the exemplary system 500 may be or include the design modules 120 and/or the rendering modules 230. It will be understood that additional, fewer, and/or alternate elements are also anticipated.

In the system 500, a rendering module 530 receives a design document 505. In some implementations, the rendering module 530 receives the design document 505 at a text layout engine 510 and/or design modules 520 that call the text layout engine 510. In particular, a text layout engine 510 (e.g., similar to and/or including system 300, text layout engine 410, text layout module 110, etc.) receives the design document 505 and performs layout calculations for one or more elements of the design document 505. For example, depending on the implementation, the text layout engine 510 may perform layout calculations for text and/or other elements as described above with regard to FIG. 3. The design modules 520 then receive the output of the text layout engine 510. For example, the design layout engine 522 (e.g., similarly to the design layout engine 422) may receive the layout calculations from the text layout engine 510 and subsequently calculate overall design layout measurements and/or painting operations to pass to design painting engine 524 (e.g., similar to the design painting engine 424), as described above.

The design layout engine 522 may additionally call and/or pass the design layout measurements to the editing module 540. In some implementations, the design layout engine 522 passes document data (e.g., details for the design document 505, a location at which the design document 505 is stored, a document type for the design document, etc.) to the editing module 540 to enable the editing module 540 to edit the design document 505. In further implementations, the editing module 540 determines the details regarding the design document separately and/or receives the details from another module (e.g., another module of the rendering modules 530, the design document 505 directly, another component communicatively coupled to system 500, etc.).

The editing module 540 may include and/or be a design document manager 542 and/or a design text editing engine 544. Depending on the implementation, the design document manager 542 and the design editing engine 544 may handle editing for different elements of the design document 505. For example, the design document manager 542 may manage editing for non-text items (e.g., resizing elements, recoloring images, modifying shapes, etc.) while the design text editing engine 544 may manage editing for text items. Depending on the implementation, the editing modules 540 may generate user interface elements (e.g., a cursor, a text editing icon, a position icon, etc.) for a user while editing the design document 505. For example, as described in more detail below with regard to FIGS. 8A-8C, the editing modules 540 may generate a position text cursor in between one or more characters of a glyph, span, line, etc. The editing modules 540 may then, responsive to receiving an input from a user (e.g., a keystroke, voice command, touch screen event, etc.), edit the design document 505 by adding a character in the indicated position. The design document 505 may then update the rendering modules 530, which paint the character to display the edited version in real-time via a user-facing output.

In some implementations, a user-facing output, such as the web application 550, receives the painted elements from the design paint engine 524. The web application 550 then displays the design document 505 as calculated and painted by the rendering modules 530. In some implementations, the web application 550 receives updated versions of the design document 505. In further implementations, the editing module 540 directly edits the output of the web application 500.

FIG. 6 depicts an example method 600 for determining whether to use client side text rendering techniques (e.g., as discussed above), browser-based client side text rendering, or server side text rendering. The method 600 may be facilitated by an electronic device (e.g., electronic device 105) that may be in communication with a server (e.g., server 110).

The method 600 begins at block 602, where the system determines whether the client device currently supports client side text rendering. If so, then flow proceeds to block 604. Otherwise, if not, then flow proceeds to block 606. In some implementations, the system determines that the client device does not support client side text rendering if the user is on a poor network (e.g., if the user needs to initially download the library). In further implementations, the system determines that the client device does not support client side text rendering if real-time updating is unnecessary or unwanted. In still further implementations, the system determines that the client device does not support client side text rendering in response to an indication from a user.

At block 604, the client device performs layout calculations using client side text rendering. In particular, the client device may perform the layout calculations by using one or more modules, engines, and/or other such components, as described above. In particular, the client device uses a platform-agnostic library to calculate design layout measurements for a design document (e.g., as described above with regard to FIG. 3).

At block 606, the system determines whether the client device currently supports browser-based client side text rendering. If so, then flow proceeds to block 608. Otherwise, if not, then flow proceeds to block 610. Depending on the implementation, the system may similarly determine whether the client device supports browser-based client side text rendering based on the platform being used (e.g., the browser in question), the network connection, user preference, etc.

At block 608, the client device performs layout calculations using browser-based client side text rendering (e.g., using libraries and/or code specific to a platform (e.g., a browser)). At block 610, the client device causes a server side device to perform the layout calculations using server side text rendering (e.g., transmitting requests back and forth between the electronic device and the server).

Referring next to FIGS. 7A-7E, the figures illustrate exemplary user interfaces 700A-700E, detailing designs generated, painted, and to be edited by the techniques described herein. In some implementations, the exemplary user interfaces are generated by the systems 100A, 100B, 100C, 200, 300, 400, and/or 500 of FIGS. 1A-5, an element of such an exemplary system, and/or some combinations of such systems. It will be understood that additional, fewer, and/or alternate elements are also anticipated.

User interface 700A depicts a 2D design 710A rendered via one or more design modules as described herein and displayed via an editing module and/or a web application, as described with regard to FIG. 5. Depending on the implementation, the user interface 700A may display the 2D design 710A as a representation of the design document, including textual and/or non-textual elements. Similarly, the user interface 700A may display one or more graphical user interface elements, such as a text editing box 715, cursor, text editing cursor, etc.

User interface 700B depicts a similar 2D design 710B rendered via one or more design modules and/or editing modules as described herein. Additionally, the user interface 700B may display one or more example products 720 using the design 710B. Some of the example products may be 2D and/or digital designs, whereas others may be 3D and/or physical designs.

User interface 700C depicts an exemplary 3D physical design 710C. Depending on the implementation, the 3D physical objects may include cups, mugs, glasses, pucks, balls, shirts, etc. In further implementations, the user interface (e.g., user interface 700D) may display one or more special textures and/or finishes, and thus displays one or more 3D reflections rather than a static image preview. Additionally, the system may determine that a location may be edited by a user and renders an editing cursor 725 to indicate where a user may input text and/or other edits. In further implementations, a user interface (e.g., user interface 700E) may additionally or alternately display of a 2D design 710E and a 3D rendering of a final product 730, updated in real-time.

Referring next to FIGS. 8A-8C, the figures illustrate exemplary spans, detailing text generated, painted, and to be edited by the techniques described herein. In some implementations, the exemplary spans are generated by the systems 100A, 100B, 100C, 200, 300, 400, and/or 500 of FIGS. 1A-5, an element of such an exemplary system, and/or some combinations of such systems. It will be understood that additional, fewer, and/or alternate elements are also anticipated.

FIG. 8A depicts a series of spans, including span 810A, span 810B, span 810C, span 810D, and span 810E (collectively referred to as spans 810). The spans 810 may include one or more glyphs comprising the entirety of the span. As used herein, “glyph” may refer to a portion of a span generated and/or treated as a single entity for the purposes of generating a span. For example, the span 810A may include a first glyph comprising the letters ‘fi’ as a single entity separate from the second glyph ‘r’ and the third glyph ‘e’. Depending on the implementation, the glyph may differ depending on the font and characters included. For example, span 810B may include the same glyphs as 810A, while 810C instead includes four glyphs, one for each of ‘f’, ‘i’, ‘r’, and ‘e’. Similarly, span 810D may include two glyphs, one for ‘f’ and one for ‘ire’, while span 810E may include two alternate glyphs, one for ‘fir’and one for ‘e’.

FIG. 8B depicts the span 810E of FIG. 8A, but in which a system generates and renders a text editing cursor 820 between two characters in a glyph. In particular, in the exemplary embodiment of FIG. 8B, the system generates and renders the text editing cursor 820 between the characters ‘f’ and ‘i’ in the glyph ‘fir’. As described herein, based on one or more parameters and/or other such characteristics of the font (e.g., inherent in the font), the system calculates a text layout (e.g., using text layout module 110) and determines characters that comprise the glyph(s) in the span 810E. The system then determines where a user may want to place the editing text cursor 820 (e.g., between individual characters in a glyph) before generating and rendering the editing text cursor 820 in such a position (e.g., responsive to a user interaction).

Similarly, FIG. 8C depicts two spans (e.g., span 830A and 830B), each depicting the editing text cursor 820 in a different position. The system may use language characteristics in determining the desired location(s) for the editing text cursor 820. In particular, while image recognition algorithms may determine that the cursor should be placed to the left of the vertical bar in 830B due to the space present in the image, length of the character in the glyph, overall size of the glyph, etc., the instant system would determine that such would impermissibly break a character apart based on one or more characteristics of the language, glyph, and/or span.

FIG. 9 depicts an example method 900 for consistently rendering documents across multiple platforms. The method 900 may be facilitated by an electronic device (e.g., electronic device 105) that may be in communication with a server (e.g., server 110).

The method 900 begins at block 902, where the client device accesses a document comprising components formatted according to a set of design elements.

At block 904, the client device divides the document into a plurality of subsections using a platform-agnostic library. In some implementations, the term ‘platform-agnostic library’ refers to a library capable of operating on multiple platforms (e.g., browsers, computing devices, etc.) while maintaining consistency in operation. In further implementations, using the platform-agnostic library includes using a platform-agnostic executable file representative of a compiled version of the platform-agnostic library. For example, a data structure generated using a platform-agnostic library should be consistent regardless of which of a plurality of platforms a user utilized in generating or using the data structure.

In some implementations, dividing the document includes dividing the document into a plurality of paragraphs. In further implementations, dividing the document then further includes dividing the plurality of paragraphs into a plurality of spans (e.g., subsections representative of respective spans) of the respective paragraph.

In further implementations, the client device additionally calculates a direction for each span. For example, the client device may calculate the direction for each span based on a font, a language, style choice, user input, etc. As an example, the client device may calculate the direction for each span as left to right when the span is in English (e.g., includes a language parameter for English), right to left when the text is in Sanskrit, top to bottom when the text is in Japanese, etc. As another example, an indication by a user that the text is or includes an acronym may cause the client device to calculate that the span for a first word is vertical (e.g., top to bottom), while the remaining spans are horizontal (e.g., left to right).

At block 906, the client deice generates, using the platform-agnostic library, lines of the document based on a size for each subsection of the plurality of subsections. Depending on the implementation, the client device may additionally position each line based on a determined position for each sub-element (e.g., words, spans, glyphs, shapes, etc.) in each line. For example, the client device may determine a length for a line based on a given size of each subsection (e.g., each span) and a size of a canvas. In some implementations, the client device may determine the length in terms of a number of subsections, a number of spans, an objective length value, etc. The client device may then generate the lines based on the determined lengths and the document, paragraphs, spans, etc.

Depending on the implementation, the client device may calculate directions for the line(s), similar to calculating the directions for the spans. For example, the client device may determine that a line should be horizontal (e.g., left to right or right to left) based on a previously calculated direction for spans associated with the line (e.g., as determined at block 904). Similarly, the client device may determine that a line should vertical (e.g., top to bottom or bottom to top) when the calculated direction for spans associated with the line is vertical.

At block 908, the client device generates, using the platform-agnostic library, a data structure. In some implementations, the client device generates the data structure by determining a position for each sub-element (e.g., words, spans, glyphs, shapes, etc.) in each line of the lines of the document (e.g., as generated in block 906). The data structure is consistent across a plurality of different platforms, as described herein.

Depending on the implementation, the client device may generate the data structure by wrapping each paragraph of the document. In some such implementations, the client device performs such a wrapping by combining the lines based on the one or more subsections as determined at block 904. Depending on the implementation, the wrapping combines the lines such that the lines maintain the determined position (e.g., as determined at block 906) regardless as to what platform the client device uses in generating and/or displaying the data structure.

In some implementations, the data structure includes one or more layout properties associated with the one or more subsections of the document. For example, the layout properties may include: (i) a position value, (ii) a rotation value, (iii) a transformation, (iv) a text orientation, (v) an alignment, (vi) a curve path indicator, (vii) a font size, (viii) a font style, (ix) text content, (x) a color of text, (xi) a stroke value for text, (xii) a font family, and/or (xiii) any other such layout property as generally discussed herein.

At block 910, the client device provides the data structure to a painting module. In some implementations, the client device provides the data structure to a painting module stored on the client device. Additionally or alternatively, the client device may provide the data structure to a painting module stored on another device (e.g., on another client device, on a server communicatively coupled to the client device, on a computing device associated with the server, etc.).

FIG. 10 depicts another example method 1000 for consistently rendering documents across multiple platforms. The method 1000 may be facilitated by an electronic device (e.g., electronic device 105) that may be in communication with a server (e.g., server 110).

The method 1000 begins at block 1002, where the client device receives a data structure indicative of a layout for one or more design elements for a document. Depending on the implementation, the data structure may be received from another module stored on a memory of the client device (e.g., text layout module 110, web assembly module 116, paragraph wrapping module 370, etc.), another client device, a server-side computing device, etc.). In some implementations, the client device receives the data structure responsive to transmitting a document layout request. Depending on the implementation, the client device transmits the document layout request for a document to a server-side computing device, another client device, a device communicatively coupled to the client device, etc.

At block 1004, the client device generates, using a platform-agnostic library, layout measurement data based on the data structure. In some implementations, the layout measurement data is consistent across a plurality of different platforms.

At block 1006, the client device generates, using the platform-agnostic library, one or more painting operations based on the data structure.

At block 1008, the client device paints element layouts at the client device based on the generated layout measurement data and the one or more painting operations. In some implementations, the client device paints the element layouts by rendering at least some of the element layouts as one or more rendered layouts. In further implementations, the client device paints element layouts by transmitting the element layouts to a painting module stored at the memory of the client device. In still further implementations, the client device paints element layouts by transmitting the element layouts to another device (e.g., another client device, a device associated with the client device (e.g., a monitor), a server-side device, etc.).

In some implementations, the client device additionally receives one or more inputs from a user. Depending on the implementation, the one or more inputs may include clicks, keystrokes, voice commands, touch screen interactions (e.g., tapping virtual buttons, receiving stroke indications in a painting module and/or operation, virtual clicks, etc.), button presses, and/or any other such user interaction (e.g., with an input device). Depending on the implementation, the client device generates a user interface element inline with the one or more rendered layouts responsive to receiving the user input (e.g., the click, touch screen interaction, button press, etc.). For example, the client device may generate a text input cursor inline with displayed text in the rendered layouts based on a click by the user. The client device may then receive one or more text inputs from the user and generate characters, shapes, objects, and/or other elements.

In some such implementations, the client device edits the element layouts in real-time based on the one or more inputs. In further implementations, the client device edits the element layouts by modifying at least some of the one or more rendered layouts in real-time based on the one or more inputs. In some such implementation, the client device edits the element layouts by modifying: (i) a position value, (ii) a rotation value, (iii) a transformation, (iv) a text orientation, (v) an alignment, (vi) a curve path indicator, (vii) a font size, (viii) a font style, (ix) text content, (x) a color of text, (xi) a stroke value for text, (xii) a font family, and/or (xiii) any other such layout element parameters as described herein.

In further implementations, the client device renders one or more example products based on (e.g., including) the element layouts. For example, the client device may render a 2D label, a 3D product, etc. when painting the element layouts (e.g., as seen with regard to FIGS. 7A-7E). In further implementations, the client device paints the element layouts and subsequently renders the one or more example products based on one or more indications from a user.

FIG. 11 depicts another example method 1100 for consistently rendering documents across multiple platforms. The method 1100 may be facilitated by an electronic device (e.g., electronic device 105) that may be in communication with a server (e.g., server 110).

The method 1100 begins at block 1102, where the client device accesses layout measurement data based on a structure indicative of a layout for one or more design elements for a document. In some implementations, the layout measurement data is the layout measurement data generated in FIG. 10.

At block 1104, the client device renders one or more editing user interface elements for inline editing based on the one or more design elements. In some implementations, the client device renders the editing user interface elements based on a text direction associated with the one or more design elements. For example, if the design elements include horizontal text, then the client device may render a user interface element for editing text vertically (e.g., in between characters of the text, as illustrated with regard to FIGS. 8A-8C). In further elements, rendering the one or more editing user interface elements is based on a font ligature associated with the one or more design elements (e.g., as illustrated with regard to FIG. 8B).

In some such implementations, the one or more editing user interface elements includes a text cursor capable of being displayed between one or more elements of a glyph of the one or more design elements. Depending on the implementation, the glyph may include multiple characters. In some such implementations, the client device may detect one or more glyphs in design text present in the one or more design elements and subsequently identify a glyph that includes multiple characters. The client device may then render the text cursor within the glyph and between at least some of the multiple characters.

In further such implementations, identifying the glyph including multiple characters is based on a language of the design text. For example, the client device may identify that a glyph includes multiple characters differently for English text than for Sanskrit text. Similarly, Japanese kanji may be a single character rather than multiple characters as may appear for English. Similarly, the client device may identify that a glyph includes multiple characters based on one or more parameters of a font for a language (e.g., indicating that two consecutive letters are to be ‘combined’into a single glyph).

In response to receiving a user input (e.g., such as a keystroke, voice command, button press, etc.), the client device may render a character associated with the one or more inputs inline with the glyph in real-time. In some implementations, the client device may delete the glyph and replace the glyph was other glyphs (e.g., including 3 characters), characters, and/or a combination of glyphs and characters.

At block 1106, the client device receives one or more inputs from a user. Depending on the implementation, the one or more inputs may include clicks, keystrokes, voice commands, touch screen interactions (e.g., tapping virtual buttons, receiving stroke indications in a painting module and/or operation, virtual clicks, etc.), button presses, and/or any other such user interaction (e.g., with an input device).

At block 1108, the client device causes a painted layout displayed to a user to be re-rendered in real-time. In some such implementations, the client device causes the painted layout to be re-rendered in real time by editing the document in real-time. Depending on the implementation, the client device edits the document based on the inputs received from the user (e.g., at block 1106).

The following list of examples reflects a variety of the embodiments explicitly contemplated by the present disclosure:
Clause 1. A computer-implemented method of consistently rendering documents across multiple platforms, the computer-implemented method comprising: accessing, by at least one processor of a client device communicating with a server-side computing device, a document comprising components formatted according to a set of design elements; dividing, by the at least one processor and using a platform-agnostic library, the document into a plurality of subsections; generating, by the at least one processor and using the platform-agnostic library, lines of the document based on a size for each subsection of the plurality of subsections; generating, by the at least one processor and using the platform-agnostic library, a data structure by determining a position for each sub-element in each line of the lines of the document, wherein the data structure is consistent across a plurality of different platforms; and providing, by the at least one processor, the data structure to a painting module stored on the client device.
Clause 2. The computer-implemented method of clause 1, wherein dividing the document includes: dividing, by the at least one processor and using the platform-agnostic library, the document into a plurality of paragraphs; and dividing, by the at least one processor and using the platform agnostic-library, the plurality of paragraphs into the plurality of subsections, wherein each subsection is representative of a span in the respective paragraph.
Clause 3. The computer-implemented method of clause 2, further comprising: calculating, by the at least one processor and using the platform-agnostic library, a direction for each span.
Clause 4. The computer-implemented method of any one of the preceding clauses, further comprising: positioning, by the at least one processor and using the platform-agnostic library, each line of the lines based on the determined position for each sub-element in each line.
Clause 5. The computer-implemented method of clause 4, wherein generating the data structure includes: wrapping, by the at least one processor and using the platform-agnostic library, each paragraph of the document by combining the lines based on the one or more subsections.
Clause 6. The computer-implemented method of any one of the preceding clauses, wherein using the platform-agnostic library includes using a platform-agnostic executable file representative of a compiled version of the platform-agnostic library.
Clause 7. The computer-implemented method of any one of the preceding clauses, wherein the data structure includes one or more layout properties associated with the one or more subsections, including at least one of: (i) a position value, (ii) a rotation value, (iii) a transformation, (iv) a text orientation, (v) an alignment, (vi) a curve path indicator, (vii) a font size, (viii) a font style, (ix) text content, (x) a color of text, (xi) a stroke value for text, or (xii) a font family.
Clause 8. A computing system configured to consistently render documents across multiple platforms, the computing system comprising: at least one processor of a client device communicating with a server-side computing device; and a memory of the client device storing one or more instructions that, when executed by the at least one processor, cause the client device to: access a document comprising components formatted according to a set of design elements; divide, using a platform-agnostic library, the document into a plurality of subsections; generate, using the platform-agnostic library, lines of the document based on a size for each subsection of the plurality of subsections; generate, using the platform-agnostic library, a data structure by determining a position for each sub-element in each line of the lines of the document, wherein the data structure is consistent across a plurality of different platforms; and provide the data structure to a painting module stored on the client device.
Clause 9. The computing system of clause 8, wherein dividing the document includes: dividing, using the platform-agnostic library, the document into a plurality of paragraphs; and dividing, using the platform agnostic-library, the plurality of paragraphs into the plurality of subsections, wherein each subsection is representative of a span in the respective paragraph.
Clause 10. The computing system of clause 9, wherein the memory further stores instructions that, when executed by the at least one processor, cause the client device to: calculate, using the platform-agnostic library, a direction for each span.
Clause 11. The computing system of any one of clauses 8-10, wherein the memory further stores instructions that, when executed by the at least one processor, cause the client device to: position, using the platform-agnostic library, each line of the lines based on the determined position for each sub-element in each line.
Clause 12. The computing system of clause 11, wherein generating the data structure includes: wrapping, using the platform-agnostic library, each paragraph of the document by combining the lines based on the one or more subsections.
Clause 13. The computing system of any one of clauses 8-12, wherein the data structure includes one or more layout properties associated with the one or more subsections.
Clause 14. The computing system of clause 13, wherein the one or more layout properties includes at least one of: (i) a position value, (ii) a rotation value, (iii) a transformation, (iv) a text orientation, (v) an alignment, (vi) a curve path indicator, (vii) a font size, (viii) a font style, (ix) text content, (x) a color of text, (xi) a stroke value for text, or (xii) a font family.
Clause 15. A tangible, non-transitory computer-readable medium storing instructions for consistently rendering documents across multiple platforms that, when executed by at least one processor, cause a client device to: access a document comprising components formatted according to a set of design elements; divide, using a platform-agnostic library, the document into a plurality of subsections; generate, using the platform-agnostic library, lines of the document based on a size for each subsection of the plurality of subsections; generate, using the platform-agnostic library, a data structure by determining a position for each sub-element in each line of the lines of the document, wherein the data structure is consistent across a plurality of different platforms; and provide the data structure to a painting module stored on the client device.
Clause 16. The tangible, non-transitory computer-readable medium of clause 15, wherein dividing the document includes: dividing, using the platform-agnostic library, the document into a plurality of paragraphs; and dividing, using the platform agnostic-library, the plurality of paragraphs into the plurality of subsections, wherein each subsection is representative of a span in the respective paragraph.
Clause 17. The tangible, non-transitory computer-readable medium of clause 16, further storing instructions that, when executed by the at least one processor, cause the client device to: calculate, using the platform-agnostic library, a direction for each span.
Clause 18. The tangible, non-transitory computer-readable medium of any one of clauses 15-17, further storing instructions that, when executed by the at least one processor, cause the client device to: position, using the platform-agnostic library, each line of the lines based on the determined position for each sub-element in each line.
Clause 19. The tangible, non-transitory computer-readable medium of clause 18, wherein generating the data structure includes: wrapping, using the platform-agnostic library, each paragraph of the document by combining the lines based on the one or more subsections.
Clause 20. The tangible, non-transitory computer-readable medium of any one of clauses 15-17, wherein the data structure includes one or more layout properties associated with the one or more subsections.
Clause 21. A computer-implemented method of consistently rendering documents across multiple platforms, the computer-implemented method comprising: receiving, by at least one processor of a client device communicating with a server-side computing device, a data structure indicative of a layout for one or more design elements for a document; generating, by the at least one processor and using a platform-agnostic library, layout measurement data based on the data structure, wherein the layout measurement data is consistent across a plurality of different platforms; generating, by the at least one processor and using the platform-agnostic library, one or more painting operations based on the data structure; and painting, by the at least one processor, element layouts at the client device based on the generated layout measurement data and the one or more painting operations.
Clause 22. The computer-implemented method of clause 21, further comprising: receiving, by the at least one processor, one or more inputs from a user; editing, by the at least one processor, the element layouts in real-time based on the one or more inputs.
Clause 23. The computer-implemented method of clause 22, wherein painting the element layouts in real-time includes: rendering, by the at least one processor, at least some of the element layouts as one or more rendered layouts; and wherein editing the element layouts in real-time includes: modifying, by the at least one processor, at least some of the one or more rendered layouts in real-time based on the one or more inputs.
Clause 24. The computer-implemented method of clause 23, wherein receiving the one or more inputs includes: receiving, by the at least one processor, a click input at a position associated with the one or more rendered layouts; generating, by the at least one processor, a user interface element inline with the one or more rendered layouts; and receiving, by the at least one processor, one or more text inputs from the user.
Clause 25. The computer-implemented method of any one of clauses 22-24, wherein editing the element layouts includes modifying at least one of: (i) a position value, (ii) a rotation value, (iii) a transformation, (iv) a text orientation, (v) an alignment, (vi) a curve path indicator, (vii) a font size, (viii) a font style, (ix) text content, (x) a color of text, or (xi) a stroke value for text.
Clause 26. The computer-implemented method of any one of clauses 21-25, further comprising: transmitting, by the at least one processor, a document layout request for a document to the server-side computing device; wherein receiving the data structure is responsive to transmitting the document layout request for the document.
Clause 27. The computer-implemented method of any one of clauses 21-26, wherein painting the element layouts includes: rendering, by the at least one processor, one or more example products including the element layouts.
Clause 28. A computing system configured to consistently render documents across multiple platforms, the computing system comprising: at least one processor of a client device communicating with a server-side computing device; and a memory of the client device storing one or more instructions that, when executed by the at least one processor, cause the client device to: receive a data structure indicative of a layout for one or more design elements for a document; generate, using a platform-agnostic library, layout measurement data based on the data structure, wherein the layout measurement data is consistent across a plurality of different platforms; generate, using the platform-agnostic library, one or more painting operations based on the data structure; and paint element layouts at the client device based on the generated layout measurement data and the one or more painting operations.
Clause 29. The computing system of clause 28, wherein the memory further stores instructions that, when executed by the at least one processor, cause the client device to: receive one or more inputs from a user; edit the element layouts in real-time based on the one or more inputs.
Clause 30. The computing system of clause 29, wherein painting the element layouts in real-time includes: rendering at least some of the element layouts as one or more rendered layouts; and wherein editing the element layouts in real-time includes: modifying at least some of the one or more rendered layouts in real-time based on the one or more inputs.
Clause 31. The computing system of clause 30, wherein receiving the one or more inputs includes: receiving a click input at a position associated with the one or more rendered layouts; generating a user interface element inline with the one or more rendered layouts; and receiving one or more text inputs from the user.
Clause 32. The computing system of any one of clauses 29-31, wherein editing the element layouts includes modifying at least one of: (i) a position value, (ii) a rotation value, (iii) a transformation, (iv) a text orientation, (v) an alignment, (vi) a curve path indicator, (vii) a font size, (viii) a font style, (ix) text content, (x) a color of text, or (xi) a stroke value for text.
Clause 33. The computing system of any one of clauses 28-32, wherein the memory further stores instructions that, when executed by the at least one processor, cause the client device to: transmit a document layout request for a document to the server-side computing device; wherein receiving the data structure is responsive to transmitting the document layout request for the document.
Clause 34. The computing system of any one of clauses 28-33, wherein painting the element layouts includes: rendering one or more example products including the element layouts.
Clause 35. A tangible, non-transitory computer-readable medium storing instructions for consistently rendering documents across multiple platforms that, when executed by at least one processor, cause a client device to: receive a data structure indicative of a layout for one or more design elements for a document; generate, using a platform-agnostic library, layout measurement data based on the data structure, wherein the layout measurement data is consistent across a plurality of different platforms; generate, using the platform-agnostic library, one or more painting operations based on the data structure; and paint element layouts at the client device based on the generated layout measurement data and the one or more painting operations.
Clause 36. The tangible, non-transitory computer-readable medium of clause 35, further storing instructions that, when executed by the at least one processor, cause the client device to: receive one or more inputs from a user; edit the element layouts in real-time based on the one or more inputs.
Clause 37. The tangible, non-transitory computer-readable medium of clause 36, wherein painting the element layouts in real-time includes: rendering at least some of the element layouts as one or more rendered layouts; and wherein editing the element layouts in real-time includes: modifying at least some of the one or more rendered layouts in real-time based on the one or more inputs.
Clause 38. The tangible, non-transitory computer-readable medium of clause 37, wherein receiving the one or more inputs includes: receiving a click input at a position associated with the one or more rendered layouts; generating a user interface element inline with the one or more rendered layouts; and receiving one or more text inputs from the user.
Clause 39. The tangible, non-transitory computer-readable medium of any one of clauses 36-38, wherein editing the element layouts includes modifying at least one of: (i) a position value, (ii) a rotation value, (iii) a transformation, (iv) a text orientation, (v) an alignment, (vi) a curve path indicator, (vii) a font size, (viii) a font style, (ix) text content, (x) a color of text, or (xi) a stroke value for text.
Clause 40. The tangible, non-transitory computer-readable medium of any one of clauses 35-39, further storing instructions that, when executed by the at least one processor, cause the client device to: transmit a document layout request for a document to the server-side computing device; wherein receiving the data structure is responsive to transmitting the document layout request for the document.
Clause 41. A computer-implemented method of consistently rendering documents across multiple platforms, the computer-implemented method comprising: accessing, by at least one processor of a client device, layout measurement data based on a data structure indicative of a layout for one or more design elements for a document; rendering, by the at least one processor, one or more editing user interface elements for inline editing based on the one or more design elements; receiving, by the at least one processor, one or more inputs from a user; and causing, by the at least one processor, a painted layout displayed to a user to be re-rendered in real-time by editing the document in real-time based on the one or more inputs from the user.
Clause 42. The computer-implemented method of clause 41, wherein rendering the one or more editing user interface elements is based on a text direction associated with the one or more design elements.
Clause 43. The computer-implemented method of clause 41 or 42, wherein rendering the one or more editing user interface elements is based on a font ligature associated with the one or more design elements.
Clause 44. The computer-implemented method of any one of clauses 41-43, wherein the one or more editing user interface elements includes a text cursor capable of being displayed between one or more elements of a glyph of the one or more design elements.
Clause 45. The computer-implemented method of clause 44, wherein the one or more design elements includes design text, further comprising: detecting, by the at least one processor, one or more glyphs in the design text; identifying, by the at least one processor, a glyph of the one or more glyphs including multiple characters; and rendering, by the at least one processor, the text cursor within the glyph and between at least some of the multiple characters.
Clause 46. The computer-implemented method of clause 45, wherein the identifying the glyph of the one or more glyphs including multiple characters is based on a language of the design text.
Clause 47. The computer-implemented method of clause 45 or 46, further comprising: rendering, by the at least one processor, a character associated with the one or more inputs from the user, inline with the glyph in real-time.
Clause 48. A computing system configured to consistently render documents across multiple platforms, the computing system comprising: at least one processor of a client device communicating with a server-side computing device; and a memory of the client device storing one or more instructions that, when executed by the at least one processor, cause the client device to: access layout measurement data based on a data structure indicative of a layout for one or more design elements for a document; render one or more editing user interface elements for inline editing based on the one or more design elements; receive one or more inputs from a user; and cause a painted layout displayed to a user to be re-rendered in real-time by editing the document in real-time based on the one or more inputs from the user.
Clause 49. The computing system of clause 48, wherein rendering the one or more editing user interface elements is based on a text direction associated with the one or more design elements.
Clause 50. The computing system of clause 48 or 49, wherein rendering the one or more editing user interface elements is based on a font ligature associated with the one or more design elements.
Clause 51. The computing system of any one of clauses 48-50, wherein the one or more editing user interface elements includes a text cursor capable of being displayed between one or more elements of a glyph of the one or more design elements.
Clause 52. The computing system of clause 51, wherein the one or more design elements includes design text and the memory further stores instructions that, when executed by the at least one processor, cause the client device to: detect one or more glyphs in the design text; identify a glyph of the one or more glyphs including multiple characters; and render the text cursor within the glyph and between at least some of the multiple characters.
Clause 53. The computing system of clause 52, wherein identifying the glyph of the one or more glyphs including multiple characters is based on a language of the design text.
Clause 54. The computing system of clause 52 or 53, wherein the memory further stores instructions that, when executed by the at least one processor, cause the client device to: render a character associated with the one or more inputs from the user, inline with the glyph in real-time.
Clause 55. A tangible, non-transitory computer-readable medium storing instructions for consistently rendering documents across multiple platforms that, when executed by at least one processor, cause a client device to: access layout measurement data based on a data structure indicative of a layout for one or more design elements for a document; render one or more editing user interface elements for inline editing based on the one or more design elements; receive one or more inputs from a user; and cause a painted layout displayed to a user to be re-rendered in real-time by editing the document in real-time based on the one or more inputs from the user.
Clause 56. The tangible, non-transitory computer-readable medium of clause 55, wherein rendering the one or more editing user interface elements is based on a text direction associated with the one or more design elements.
Clause 57. The tangible, non-transitory computer-readable medium of clause 55 or 56, wherein rendering the one or more editing user interface elements is based on a font ligature associated with the one or more design elements.
Clause 58. The tangible, non-transitory computer-readable medium of any one of clauses 55-57, wherein the one or more editing user interface elements includes a text cursor capable of being displayed between one or more elements of a glyph of the one or more design elements.
Clause 59. The tangible, non-transitory computer-readable medium of clause 58, wherein the one or more design elements includes design text, and further storing instructions that, when executed by the at least one processor, cause the client device to: detect one or more glyphs in the design text; identify a glyph of the one or more glyphs including multiple characters; and render the text cursor within the glyph and between at least some of the multiple characters.
Clause 60. The tangible, non-transitory computer-readable medium of clause 59, wherein identifying the glyph of the one or more glyphs including multiple characters is based on a language of the design text.
Clause 61. A computing system configured to consistently render documents across multiple platforms, the computing system comprising: at least one processor of a client device communicating with a server-side computing device; and a memory of the client device storing one or more instructions that, when executed by the at least one processor, cause the client device to implement a method according to any one of clauses 1-7, 21-27, or 41-47.

Although the following text sets forth a detailed description of numerous different embodiments, it should be understood that the legal scope of the invention may be defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical.

1. A computer-implemented method of consistently rendering documents across multiple platforms, the computer-implemented method comprising:
accessing, by at least one processor of a client device communicating with a server-side computing device, a document comprising components formatted according to a set of design elements;
dividing, by the at least one processor and using a platform-agnostic library, the document into a plurality of subsections;
generating, by the at least one processor and using the platform-agnostic library, lines of the document based on a size for each subsection of the plurality of subsections;
generating, by the at least one processor and using the platform-agnostic library, a data structure by determining a position for each sub-element in each line of the lines of the document, wherein the data structure is consistent across a plurality of different platforms; and
providing, by the at least one processor, the data structure to a painting module stored on the client device.

2. The computer-implemented method of claim 1, wherein dividing the document includes:
dividing, by the at least one processor and using the platform-agnostic library, the document into a plurality of paragraphs; and
dividing, by the at least one processor and using the platform-agnostic library, the plurality of paragraphs into the plurality of subsections, wherein each subsection is representative of a span in the respective paragraph.

3. The computer-implemented method of claim 2, further comprising:
calculating, by the at least one processor and using the platform-agnostic library, a direction for each span.

4. The computer-implemented method of claim 1, further comprising:
positioning, by the at least one processor and using the platform-agnostic library, each line of the lines based on the determined position for each sub-element in each line.

5. The computer-implemented method of claim 4, wherein generating the data structure includes:
wrapping, by the at least one processor and using the platform-agnostic library, each paragraph of the document by combining the lines based on the plurality of subsections.

6. The computer-implemented method of claim 1, wherein using the platform-agnostic library includes using a platform-agnostic executable file representative of a compiled version of the platform-agnostic library.

7. The method of claim 1, wherein the data structure includes one or more layout properties associated with the plurality of subsections, including at least one of: (i) a position value, (ii) a rotation value, (iii) a transformation, (iv) a text orientation, (v) an alignment, (vi) a curve path indicator, (vii) a font size, (viii) a font style, (ix) text content, (x) a color of text, (xi) a stroke value for text, or (xii) a font family.

8. A computing system configured to consistently render documents across multiple platforms, the computing system comprising:
at least one processor of a client device communicating with a server-side computing device; and
a memory of the client device storing one or more instructions that, when executed by the at least one processor, cause the client device to:
access a document comprising components formatted according to a set of design elements;
divide, using a platform-agnostic library, the document into a plurality of subsections;
generate, using the platform-agnostic library, lines of the document based on a size for each subsection of the plurality of subsections;
generate, using the platform-agnostic library, a data structure by determining a position for each sub-element in each line of the lines of the document, wherein the data structure is consistent across a plurality of different platforms; and
provide the data structure to a painting module stored on the client device.

9. The computing system of claim 8, wherein dividing the document includes:
dividing, using the platform-agnostic library, the document into a plurality of paragraphs; and
dividing, using the platform-agnostic library, the plurality of paragraphs into the plurality of subsections, wherein each subsection is representative of a span in the respective paragraph.

10. The computing system of claim 9, wherein the memory further stores instructions that, when executed by the at least one processor, cause the client device to:
calculate, using the platform-agnostic library, a direction for each span.

11. The computing system of claim 8, wherein the memory further stores instructions that, when executed by the at least one processor, cause the client device to:
position, using the platform-agnostic library, each line of the lines based on the determined position for each sub-element in each line.

12. The computing system of claim 11, wherein generating the data structure includes:
wrapping, using the platform-agnostic library, each paragraph of the document by combining the lines based on the plurality of subsections.

13. The computing system of claim 8, wherein the data structure includes one or more layout properties associated with the plurality of subsections.

14. The computing system of claim 13, wherein the one or more layout properties includes at least one of: (i) a position value, (ii) a rotation value, (iii) a transformation, (iv) a text orientation, (v) an alignment, (vi) a curve path indicator, (vii) a font size, (viii) a font style, (ix) text content, (x) a color of text, (xi) a stroke value for text, or (xii) a font family.

15. A tangible, non-transitory computer-readable medium storing instructions for consistently rendering documents across multiple platforms that, when executed by at least one processor, cause a client device to:
access a document comprising components formatted according to a set of design elements;
divide, using a platform-agnostic library, the document into a plurality of subsections;
generate, using the platform-agnostic library, lines of the document based on a size for each subsection of the plurality of subsections;
generate, using the platform-agnostic library, a data structure by determining a position for each sub-element in each line of the lines of the document, wherein the data structure is consistent across a plurality of different platforms; and
provide the data structure to a painting module stored on the client device.

16. The tangible, non-transitory computer-readable medium of claim 15, wherein dividing the document includes:
dividing, using the platform-agnostic library, the document into a plurality of paragraphs; and
dividing, using the platform-agnostic library, the plurality of paragraphs into the plurality of subsections, wherein each subsection is representative of a span in the respective paragraph.

17. The tangible, non-transitory computer-readable medium of claim 16, further storing instructions that, when executed by the at least one processor, cause the client device to:
calculate, using the platform-agnostic library, a direction for each span.

18. The tangible, non-transitory computer-readable medium of claim 15, further storing instructions that, when executed by the at least one processor, cause the client device to:
position, using the platform-agnostic library, each line of the lines based on the determined position for each sub-element in each line.

19. The tangible, non-transitory computer-readable medium of claim 18, wherein generating the data structure includes:
wrapping, using the platform-agnostic library, each paragraph of the document by combining the lines based on the plurality of subsections.

20. The tangible, non-transitory computer-readable medium of claim 15, wherein the data structure includes one or more layout properties associated with the plurality of subsections.
